(19) United States
(12) Patent Application Publication
(10) Pub. No.: US 2002/0063368 A1
(43) Pub. Date: May 30, 2002

(54) Mesh bearing damper for an energy storage rotor

(76) Inventor: Omar M. Kabir, Delanson, NY (US)

Correspondence Address: Dike, Bronstein, Roberts & Cushman, Intellectual Property Practice Group, Edwards & Angell, LLP, 130 Water Street, Boston, MA, 02109, US

(21) Appl. No.: 09/728,822

(22) Filed: Nov. 29, 2000

(51) Int. Cl. B60G 11/18; F16F 1/14; F16F 1/36

(52) U.S. Cl. 267/147; 267/273; 267/154

(57) ABSTRACT

The present invention discloses a fluid-free mesh bearing damper, e.g., for a flywheel energy storage device. The disclosed mesh bearing damper is uniquely suitable for use in combination with flywheel assemblies, which typically are evacuated by one or more pumps to create a vacuum to substantially minimize energy loss due to air friction, because, among others, the disclosed bearing damper does not use fluids, e.g., pressurized oil, that may affect deleteriously the operation of the pumps. Moreover, the disclosed bearing damper damps vibrations, i.e., reduces the amplitude of the vibrations, induced by the rotating shaft, deflection of the shaft, and/or by the misalignment, or eccentricity, of the shaft; substantially lowers the load on the bearings, which enhances the life of the bearings and facilitates magnetic levitation; and transfers heat away from the bearings, which, further, enhances the life of the bearings. The disclosed bearing damper comprises at least one, e.g., copper, aluminum, carbon fiber, etc., circular mesh disk, which is in tight interference fit with the shaft bearing at the disk's inner periphery.

### FIELD OF THE INVENTION

The present invention relates to a damping device for the bearings of an energy storage system. More precisely, the invention relates to a fluid-less, mesh bearing damper for bearings supporting rotors for a flywheel assembly, which substantially lowers the amplitude of vibrations; substantially lowers loads on the rotor; and enhances heat transfer away from the bearings, prolonging bearing life.

### DESCRIPTION OF THE RELATED ART

Energy storage systems, which internally produce and store kinetic energy in high speed rotors, or flywheels, have been developed as an alternative to batteries and other means of storing energy for at least about 30 years. Energy storage systems typically comprise an energy-storing rotor, which includes an outer rim commonly made of high-strength, low-density composite fibers that maximize energy storage density, and a high-powered, high-strength generator, which turns the rotor at high rotational velocities. To reduce energy loss through air friction, flywheel systems often, if not exclusively, are contained in an evacuated chamber, which is evacuated by at least one pump, and preferably by two or more pumps.

Flywheel rotors are supported on and guided by bearings that permit free motion between a moving part, e.g., a flywheel rotor shaft, and a fixed part. Bearings minimize energy loss associated with friction and, further, minimize wear and tear on moving and fixed parts.

Mechanical bearings of the roller- or ball-type, which typically are made of metal, alloys or composite materials, transmit loads imparted to the bearing by the moving part to a fixed support. Mechanical bearings of the hydrostatic fluid-type transfer loads to a high-pressure fluid film that separates moving from stationary parts, further lubricating the moving part. To protect and extend the useful life of mechanical bearings, low radial stiffness, which reduces the dynamic force acting on the bearings, is preferred. Moreover, mechanical bearings require damping to effectively minimize the amplitude of vibrations, especially at or near critical, i.e., resonant, frequency.

Bearing dampers are well known to those skilled in the art and, traditionally, have followed one of two schools of practice: squeeze film-type dampers (FIG. 1) and leaf spring-type dampers (FIG. 2). The advantages of squeeze film-type dampers are adequately disclosed in patents to Mild (U.S. Pat. No. 4,023,868), Ida et al. (U.S. Pat. No. 4,392,751), Monzel et al. (U.S. Pat. No. 5,071,262), Bobo (U.S. Pat. No. 5,149,206), and Stallone et al. (U.S. Pat. No. 5,344,239). Similarly, the advantages of leaf spring-type dampers are provided in the patent to Je et al. (U.S. Pat. No. 5,553,834). However, the above-mentioned patents commonly introduce a fluid, e.g., pressurized oil, into the bearing damper. As a result, in each instance, fluid is likely to escape from the pressure chamber. Were such fluid, especially oil, to escape into the evacuated chamber of an energy storage system, the effect on the system would be catastrophic.

The Miki patent discloses a bearing damper that injects fluid under pressure into a chamber that automatically adjusts the bearing pre-load. The Ida et al. patent discloses a fluid film damper, which, in combination with a spring, damps vibrations produced by the rotating shaft. Means are provided in the latter patent to adjust the damping coefficient of the fluid film damper by adjusting the geometry and dimensions of the fluid gap. Each of these patents, however, is likely to leak fluid. Therefore, they are unsuitable for use in conjunction with an evacuated energy storage system.

Several of the above-mentioned patents address methods of and devices for controlling fluid leakage in a bearing damper. Monzel et al. discloses a fluid control device for a squeeze film-type damper, wherein a pair of piston-type rings functions to retain oil in a squeeze-film chamber. The Stallone et al. patent discloses a double annular wall that is used to seal the pressure chamber. Both of these patents, however, expressly provide that the rings and/or double annular wall only “minimize” oil leakage. Thus, oil leakage is never fully arrested and leakage will undoubtedly occur. The Bobo patent discloses a “ring and groove” seal means that prevents discharge of high-pressure damper fluid by the eccentric motion of the ring in the groove. This invention, however, purposely allows fluid from the low-pressure end to escape as a means of preserving the damping potential of the high-pressure fluid at the high-pressure end. Thus, leakage, albeit somewhat controlled, is still likely, if not certain, to occur.

The leaf spring-type damper patent to Je et al. discloses a plurality of leaf spring packs circumferentially installed between an inner and an outer ring to provide damping of rotary shaft vibrations and to account for misalignment, and imbalances associated therewith, of the rotary shaft. The leaf spring packs are in sliding tangential contact with the outer surface of an inner ring and elastically support the inner ring. Fluid, e.g., oil, flows through passages between the packs to provide damping. As a result, the fluid may leak from this bearing damper. Consequently, this leaf spring damper-type is equally unsuitable for use in conjunction with an evacuated energy storage device.

### SUMMARY OF THE INVENTION

Thus, it would be desirable to produce a bearing damper that damps vibrations, i.e., reduces the amplitude of the vibrations, induced by the rotating shaft, deflection of the shaft, and/or by the misalignment, or eccentricity, of the shaft. Moreover, it would be desirable to produce a bearing damper that substantially lowers the load on the bearings, which enhances the life of the bearings and facilitates magnetic levitation. Furthermore, it would be desirable to produce a damping device that transfers heat away from the bearings, which, further, enhances the life of the bearings. Finally, it would be desirable to produce a bearing damper that does not use fluids in operation, in order to eliminate problems associated with fluid leakage into an evacuated chamber.

Therefore, it is an object of the present invention to provide a bearing damper that provides sufficient radial damping to protect mechanical bearings by substantially lowering the amplitude of vibrations.

It is another object of the present invention to provide a bearing damper that substantially lowers the load on the bearing to enhance bearing life.

It is a further object of the present invention to provide a bearing damper that provides minimal radial stiffness to enhance bearing life.

It is a yet another object of the present invention to provide a bearing damper that provides minimal axial and transverse stiffness to substantially minimize operating moments and to allow magnetic levitation.

It is still another object of the present invention to provide a bearing damper that substantially enhance bearing life by transferring heat away from the bearings.

It is a further object of the present invention to provide a bearing damper that does not use fluids, e.g., oil, in operation to eliminate leakage concerns.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 is an illustrative example of a prior art fluid film-type bearing damper from U.S. Pat. No. 5,344,239;

FIG. 2 is illustrative example of a prior art leaf spring-type bearing damper from U.S. Pat. No. 5,553,834;

FIG. 3 is a cut-away section of an illustrative embodiment of the present invention at the end of a rotary shaft;

FIG. 4 is an illustrative embodiment of a mesh damper for the bearings of a rotating energy storage system; and

FIG. 5 is a sectional view of the mesh bearing damper in FIG. 4.

### DETAILED DESCRIPTION OF THE INVENTION AND ITS

### PREFERRED EMBODIMENTS

Flywheel-based energy storage devices comprise relatively simple devices for readily storing and recovering energy. Conceptually, as a flywheel spins, mechanical kinetic energy is stored, e.g., primarily in the outermost portion (the “rim”) of the flywheel assembly. The amount of energy stored in a flywheel assembly is directly proportional to its mass and to the square of the rotational velocity of the flywheel. Consequently, those skilled in the art continue to develop flywheels that rotate at ever-increasing velocities.

In accordance with FIG. 3, a rotating shaft 100 turns the flywheel of an energy storage device. A plurality of bearings 10 supports and guides the shaft 100; permits free motion between the moving rotary shaft 100 and fixed parts; minimizes energy loss and wear and tear due to friction; and dampens vibrations produced by the rotary shaft 100 and/or flywheel assembly. Notwithstanding the significance of the other, interrelated bearing 10 functions, supporting the rotary shaft 100 and damping vibrations during operation may be its primary role. This is especially true in connection with flywheel assemblies.

Indeed, state-of-the-art energy storage systems rotate a flywheel that comprises a high-tensile strength, low-density material, e.g., composite fiber material, outer rim, which substantially increases the energy storage potential of the flywheel. Correspondingly, however, this combination of low-density materials rotating at very high speeds produces a compatibility problem that typically manifests as vibrations that affect the performance and life of the flywheel assembly. As the flywheel rotates at great speed, the outer, composite rim of the flywheel “grows” radially and “shrinks” axially due to the effect of centrifugal force, which creates significant hoop and radial stresses in the outer rim. If the hub, which interconnects the expansive outer rim to the stiff, non-expansive rotary shaft 100, does not “grow” commensurately with the growth of the outer rim, gaps appear at discrete locations as the outer rim separates from the hub. These gaps produce vibrations that can be detrimental or, in the case of resonance, destructive to the functioning of the flywheel assembly.

Another source of vibrations, which requires damping, is caused by the eccentricity of the flywheel itself. Indeed, inherent flywheel imbalances and/or imbalances due to rotor deflection or axial misalignment generate vibrations that can be equally as detrimental and/or destructive to the flywheel assembly as vibrations produced by the non-compatibility of materials making up the elements of a flywheel assembly. As a result, it is imperative that bearings 10 for a rotary shaft 100 provide flexible support and, moreover, good radial damping.

Low radial stiffness reduces the dynamic forces acting on mechanical bearings 10. Indeed, bearings 10 with low radial stiffness experience less wear and tear and enjoy a longer life. Low transverse stiffness avoids excessive moment resulting from rotor 100 eccentricity that may be due to deflection of the rotor 100 and/or axial misalignment. Low axial stiffness enhances shaft 100 levitation at magnetic bearings 10. Finally, damping reduces the amplitude of vibrations to the rotor 100, which is especially important at or near critical velocity, or frequency, of the flywheel assembly.

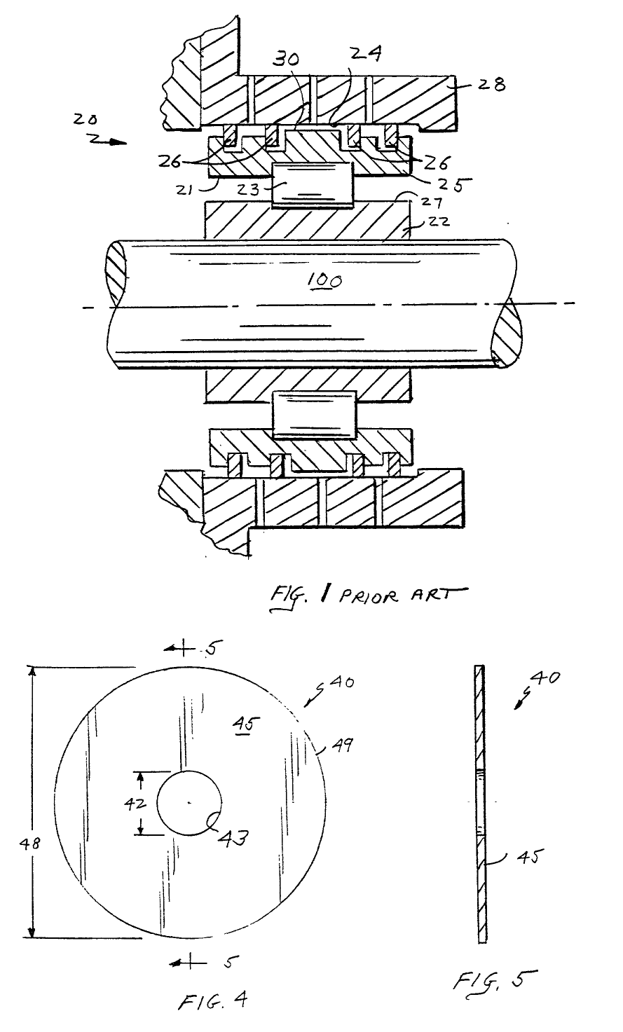

An illustrative example of a prior art fluid film-type damper 20 is show in FIG. 1. A fluid film-type damper 20 introduces fluid, e.g., oil, under relatively high pressure into a squeeze film chamber 24 between a bearing housing 28 and the outer race of the bearing 25. The inner race of the bearing 22 is in tight interference fit with the rotary shaft 100. A rolling element 23 is situated between and confined by the outer face 27 of the inner race 22 and the inner face 21 of the outer race 25.

The shaft 100 and the inner race 22 rotate together. The rolling element 23 rolls along the outer face 27 of the inner race 22 and the inner face 21 of the outer race 25, transferring loads to the outer race 25. The outer race 25 does not rotate. When the shaft 100 displaces in a radial direction, displacement that is approximately equal in magnitude and direction is transmitted to the outer face 30 of the outer race 25.

A self-governing oil film, which provides hydrostatic lubrication between the outer face 30 of the outer race 25 and the bearing housing 28, absorbs and dampens the movement and corrects the imbalance. A plurality of barriers 26 is provided to contain the oil film in the squeeze film chamber 24. However, oil leakage past the barriers 26 is common among fluid film-type bearings 20. Fluids, especially oil, should not be introduced into an evacuated energy storage system as the fluid might penetrate and affect the pumps.

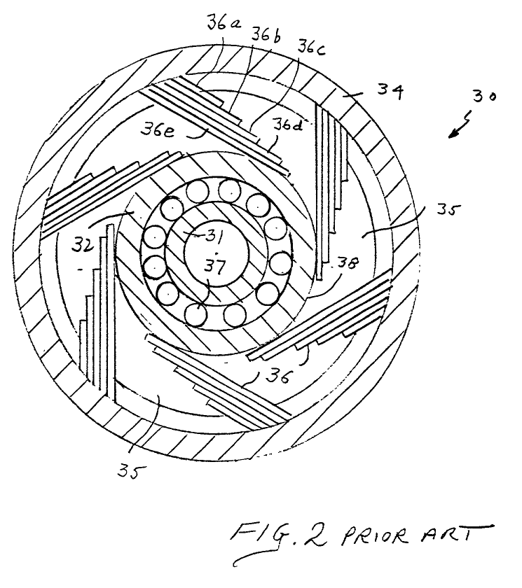

In a second illustrative example of the prior art, FIG. 2 shows a leaf spring-type damper 30. A leaf spring-type damper 30 typically comprises a plurality of rings 31, 32, 34, shown for illustrative purposes only as an inner race 31, which is in tight interference fit with the rotary shaft (not shown), an outer race 32, and a damper housing 34. A rolling element 37 is situated between and confined by the outer face of the inner race 31 and the inner face of the outer race 32. Situated between the outer race 32 and damper housing 34 is a plurality of spring packs 36, comprising a plurality of spring leafs 36a, 36b, 36c, 36d, and 36e, which are circumferentially installed between the outer 32 and damper housing 34. The leaf spring packs 36 are in sliding tangential contact with the outer surface 38 of the outer race 32 and elastically support the outer race 32. Fluid, e.g., oil, flows through a plurality of passages 35 between adjacent spring packs 36 to provide damping. Consequently, leaf spring-type bearings 30 also may leak fluid. Here again, oil leakage into an evacuated energy storage system would be deleterious.

The present invention (FIGS. 3, 4, and 5) comprises a fluid-free mesh bearing damper 40, comprising at least one mesh disk 45. An illustrative embodiment (FIG. 3) depicts the end of a rotary shaft 100 supported by a bearing 10, which, for illustrative purposes only, is a mechanical bearing 10.

The bearing 10 comprises an inner race 11 and an outer race 12 with a rolling element 13 situated and confined therebetween. The bearing 10 is locked onto the end of the shaft 100 with a bearing lock nut 14.

The inner surface 43 of the mesh bearing damper 40 is in tight interference fit with the outer face 16 of the outer race 12. The outer periphery 49 of the mesh bearing damper 40 is further confined and axially constrained in a groove 19 of a clamp 18. The clamp 18 is fixedly secured, e.g., by a plurality of screws 17, to a mounting plate 15, which plate is further fixedly secured to the energy storage device (not shown). Those skilled in the art may practice this disclosed invention using any clamping means and/or clamp securing means for attaching the clamping means to the mounting plate 15 without violating the scope and spirit of the present invention.

In comparison to other types of dampers, mesh dampers 40 produce an optimal relationship between stiffness and damping, which is to say that mesh dampers 40, especially mesh dampers 40 fabricated from metallic materials, e.g., aluminum, copper, etc., provide relatively high levels of damping at correspondingly, relatively low levels of stiffness. Dampers 40 fabricated from elastomers also provide sufficient damping and relative flexibility. Solid dampers fabricated from the same or similar materials as a comparable mesh damper 40 would be overly rigid.

Dampers 40 should be relatively flexible with correspondingly low axial, radial, and transverse stiffness. For example, it is undesirable for a damper 40 to affect the lift system of a rotor that is supported by magnetic bearings. Consequently, axial stiffness is maintained as low as possible. In another example, low radial stiffness reduces the dynamic force acting on the bearing, which can extend the service life of the bearings 10. In yet another example, stiffer dampers 40 produce stiffer flywheel assemblies, which are more susceptible to problems associated with imbalances resulting from imperfect leveling.

As a result, an ideal damper produces (i) low damping when a flywheel assembly is operating at high speeds; (ii) high damping when a flywheel assembly is operating at low speeds; and (iii) minimal damping at or near the critical velocity. Indeed, critical velocity is proportional to damper stiffness. The less stiff the damper, the lower the critical velocity, which requires relatively less damping as the flywheel assembly operates at or near its critical velocity. The opposite is also true, i.e., in relative terms, the greater the stiffness, the higher the critical velocity. As a result, relatively more damping of the flywheel assembly is required at or near its critical velocity.

A rotor dynamic study on a flywheel operating between about 200 and about 250 Hertz indicates that the bearings 10 require a radial stiffness between about 1500 and about 5000 pounds/inch (lb/in), an axial stiffness between about 100 and about 300 lb/in, a transverse stiffness between about 1 and about5 lb/in, and a radial damping between about 1 and about 10 pound-seconds/inch (lb-sec/in). In a preferred, working embodiment, a mesh bearing damper 40 comprising two mesh disks 45, each having an outer diameter 48 of about 5.4 inches (in.), an inner diameter 42 of about 1.4 in., and a thickness of about 0.30 in., produces a combined radial stiffness of between about 1500 and 4000 lb/in, a combined axial stiffness of about 200 lb/in, a combined transverse stiffness of about 5 lb/in, and a combined radial damping of about 5 lb-sec/in.

It should be noted, however, that this invention may be practiced using mesh disks 45 of any inner 42 or outer diameter 48 and/or thickness without violating the scope and spirit of this disclosure. Generally, the size of the bearings 10 and available space determine the dimensions and geometry of the mesh bearing damper 40. Thicker mesh disks 45, whether singly or in combination, produce a stiffer mesh bearing damper 40. In the preferred embodiment described above, two mesh disks 45 were sandwiched together for an overall thickness of about 0.60 in.

Any number of mesh disks 45 may be used to produce a mesh bearing damper 40. For illustrative purposes only, the mesh bearing damper 40 in FIG. 3 is shown as a combination of two mesh disks 45. Mesh disks 45 do not have to be adhesively or fixedly attached to adjacent mesh disks 45, but an adhesive means or other means can be used to attach adjacent mesh disks 45 without violating the scope and spirit of the present invention.

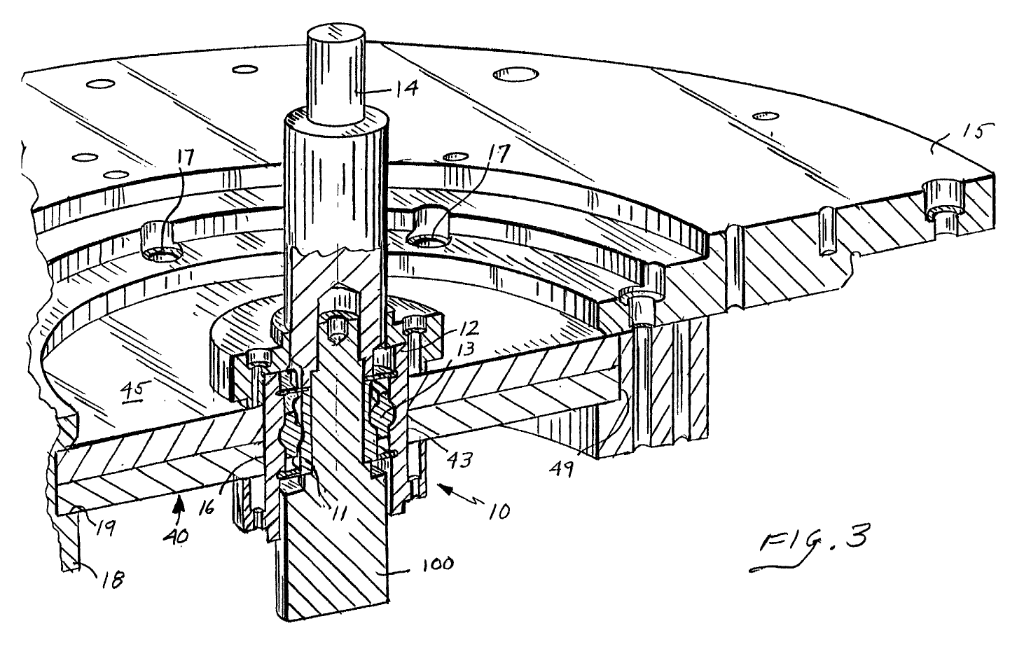

Mesh disks 45 can be made of, e.g., metal, alloys, and/or carbon composite materials (FIGS. 4 and 5). Moreover, mesh bearing damper 40 may include a plurality of mesh disks 45 composed of similar or dissimilar materials. In a preferred embodiment, mesh disks 45 for mesh bearing dampers 40 are made of oxygen free copper, which provides sufficient flexibility and damping and is an excellent conductor.

Mesh disks 45 may be manufactured by weaving, e.g., copper, wire into a coil and then forming the mesh disks 45 with a die. It should be noted, however, that other means of manufacturing mesh disks 45 can be practiced without violating the spirit and scope of the disclosed invention. The dimensions and geometry of the mesh bearing damper 40 and the mesh disks 45 that comprise it may be varied to provide any desired stiffness and/or damping.

Employing multiple mesh disks 45 in combination to produce a bearing damper 40 further allows one to use disks 45 of different compositions. Indeed, at least one, e.g., metal mesh disk 45 could be combined with at least one, e.g., carbon composite mesh disk 45 to produce suitable mesh bearing dampers 40.

An added feature of the present invention is that the mesh bearing damper 40 is in direct communion with the bearing 10, which generates heat due to friction. The mesh disk(s) 45 comprising the mesh bearing damper 40 conduct heat away from the bearing 10 to the outer periphery 49 of the mesh disk(s) 45. The generally open nature of the mesh weavings facilitates heat transfer from the mesh wires to the cooling environment. In a preferred embodiment, the mesh disks 45 are made of copper, which is an excellent conductor. Carbon-carbon materials are also excellent conductors, especially when the carbon fibers are oriented in a radial direction.

While a number of embodiment of the invention has been described, it should be obvious to those of ordinary skill in the art that other embodiments to and/or modifications, combinations, and substitutions of the present invention are possible, all of which are within the scope and spirit of the disclosed invention.

What is claimed is:

1. A fluid-less damper for a bearing of an energy storage device.

2. A bearing damper as recited in claim 1, comprising at least one mesh disk.

3. A bearing damper as recited in claim 2, wherein said mesh disk, having an outer periphery, is confined in and axially restrained by a groove of a clamping device at the outer periphery of the mesh disk.

4. A bearing damper as recited in claim 3, wherein the clamping device is fixedly secured to a mounting plate in the energy storage device.

5. A bearing damper as recited in claim 2, wherein said mesh disk is fabricated from a material selected from a group comprising copper, aluminum, and carbon fiber composite materials.

6. A bearing damper as recited in claim 2, wherein the bearing damper comprises a plurality of mesh disks that are fixedly attached together.

7. A bearing damper as recited in claim 2, wherein said mesh disks are made of similar material.

8. A bearing damper as recited in claim 1, wherein said mesh disks are made of dissimilar materials.

9. A bearing damper as recited in claim 7, wherein the similar material comprises oxygen free copper.

10. A bearing damper as recited in claim 1, wherein the bearing damper provides a radial stiffness between about 1500 and about 5000 pounds per inch.

11. A bearing damper as recited in claim 10, wherein the bearing damper provides a radial stiffness between about 1500 and about 4000 pounds per inch.

12. A bearing damper as recited in claim 1, wherein the bearing damper provides an axial stiffness between about 100 to about 300 pounds per inch.

13. A bearing damper as recited in claim 12, wherein the bearing damper provides an axial stiffness of about 200 pounds per inch.

14. A bearing damper as recited in claim 1, wherein the bearing damper provides a transverse stiffness between about 1 and about 5 pounds per inch.

15. A bearing damper as recited in claim 14, wherein the bearing damper provides a transverse stiffness of about 5 pounds per inch.

16. A bearing damper as recited in claim 1, wherein the bearing damper provides a radial damping between about 1 and about 10 pound-seconds per inch.

17. A bearing damper as recited in claim 16, wherein the bearing damper provides a radial damping between about 5 pound-seconds per inch.

18. A system for damping vibrations produced by a flywheel assembly of an energy storage device, having a rotary shaft, comprising at least one fluid-freebearing damper.

19. A system for damping vibrations produced by a flywheel assembly as recited in claim 18, wherein said fluid-free bearing damper provides a radial stiffness between about 1500 and about 5000 pounds per inch.

20. A system for damping vibrations produced by a flywheel assembly as recited in claim 19, wherein said fluid-less bearing damper provides a radial stiffness between about 1500 and about 4000 pounds per inch.

21. A system for damping vibrations produced by a flywheel assembly as recited in claim 18, wherein said fluid-free bearing damper provides an axial stiffness between about 100 and about 300 pounds per inch.

22. A system for damping vibrations produced by a flywheel assembly as recited in claim 21, wherein said fluid-free bearing damper provides an axial stiffness of about 200 pounds per inch.

23. A system for damping vibrations produced by a flywheel assembly as recited in claim 18, wherein said fluid-free bearing damper provides a transverse stiffness between about 1 and about 5 pounds per inch.

24. A system for damping vibrations produced by a flywheel assembly as recited in claim 23, wherein said fluid-free bearing damper provides a transverse stiffness of about 5 pounds per inch.

25. A system for damping vibrations produced by a flywheel assembly as recited in claim 18, wherein said fluid-free bearing damper provides a radial damping less between about 1 and about 10 pound-seconds per inch.

26. A system for damping vibrations produced by a flywheel assembly as recited in claim 25, wherein said fluid-free bearing damper provides a radial damping of about 5 pound-seconds per inch.
